(19) United States
(12) Patent Application Publication
(10) Pub. No.: US 2005/0260245 A1
(43) Pub. Date: Nov. 24, 2005

(54) Carrier material for biological mosquito-larvae killing pesticides, and mosquito-larvae killing products and procedure of their manufacture, and mosquito larvae extermination method with spreading them from air and water-craft

(76) Inventors: Laszlo Kotai, Erd (HU); Lajos Imreh, Budakeszi (HU); Josef Lippart, Budapest (HU); Erno Tamics, Budapest (HU)

Correspondence Address: LADAS & PARRY, 26 WEST 61ST STREET, NEW YORK, NY, 10023, US

(21) Appl. No.: 11/003,251

(22) Filed: Dec. 3, 2004

Related U.S. Application Data
(63) Continuation of application No. PCT/HU03/00039, filed on Jun. 2, 2003.

(30) Foreign Application Priority Data
Jun. 6, 2002 (HU) P0201908

(51) Int. Cl. A01N 25/08; A01N 25/26

(52) U.S. Cl. 424/417

(57) ABSTRACT

A carrier material for biological mosquito-larvae-killing pesticides, comprising granules with a given size and geometrical form, mechanical strength, which contain pores, and basically build from a natural silicate mineral has been prepared from a porous and burnt clay material. Geometrical form of the granules is favorably ball form, size of the supporting material granules is 0.1-20 mm, preferably 3-6 mm in its diameter. A procedure for the preparation of the carrier material is also given in which the pesticide material is bound on the surface or into the pores of the carrier material. The granules float on the water surface until it has its effects, then within a few hours, preferably between 1-16 hours its pores are filled with water then sinks.

The subject of the current invention is a carrier material for biological mosquito larvae killing pesticides, and mosquito-larvae killing products and procedure of their manufacture, and mosquito larva extermination method with spreading them from air- or water-craft.

Several mechanical instruments are known to collect and destroy [U.S. Pat. No. 6,298,011, U.S. Pat. No. 5,896,697,U.S. Pat. No. 4,328,636, JP 63,063,332] the trapped blood-sucking mosquitos and their larvaes by light [U.S. Pat. No. 5,815,980 U.S. Pat. No. 6,112,453], feromones [U.S. Pat. No. 4,803,298, EP 194,077] and in other ways [U.S. Pat. No. 5,123,201 U.S. Pat. No. 4,061,038 AU 5,940,800 U.S. Pat. No. 3,997,999], respectively.

In order to destroy mosquito larvae insecticide products belonging to different compound groups have been developed [GB 912,895 GB 968,058, GB 207,802, GB 2,079,604, GB 2,079,603, RU 2,077,203, GB 1,016,666, GB 1,097,790, GB 1,081,763, U.S. Pat. No. 3,939,273, U.S. Pat. No. 3,973,040 U.S. Pat. No. 4,342,777, U.S. Pat. No. 4,357,344, U.S. Pat. No. 4,391,828, U.S. Pat. No. 4,721,727, U.S. Pat. No. 4,482,728, U.S. Pat. No. 4,400,510, U.S. Pat. No. 3,358,011, U.S. Pat. No. 3,920,846, U.S. Pat. No. 3,492,375, U.S. Pat. No. 3,440,245, U.S. Pat. No. 4,211,778, U.S. Pat. No. 4,280,999, U.S. Pat. No. 4,855,319, U.S. Pat. No. 4,569,947, U.S. Pat. No. 4,070,365, U.S. Pat. No. 4,156,007, U.S. Pat. No. 3,759,993, DE 2,126,684, EP 86,411, EP 498,720, CN 1,058,041, CN 1,297,680, U.S. Pat. No. 4,174,393, CH 647,392, CH 641,391, CH 647,131, CH 602,003, JP 57,128,615, JP 57,106,602,], and the ever increasing need for protecting the environment have led to the introduction of various biological pesticides [U.S. Pat. No. 5,830,722, U.S. Pat. No. 5,830,722, U.S. Pat. No. 4,206,281, CN 1,050,667, FR 2,639,959, WO 00/62,620, EP 417,906, U.S. Pat. No. 4,316,959, WO 98/28984, DE 4,133,889, WO 98/39974, EP 349,769, U.S. Pat. No. 4,918,006, WO 92/8354, SU 1,515,425, SU 1,305,916, RU 2,111,667, RU 2,031,579].

With regard to the fact that mosquito larvaes live on water surface, various flotaing supports [U.S. Pat. No. 4,650,792, GB 650,132, U.S. Pat. No. 4,228,614] have been developed as carriers for various chemical or biological pesticides. The main disadvantages of these components are that they frequently contain plastics that cannot decompose, and their weight is too small for long-distance spreading. For example, products containing cork show negative features, they are not strong mechanically, therefore during transportation, storage and mechanical employment the quality of the product deteriorates.

One of the main disadvantages of the widely used products consisting a mixture of pieces of cork and plaster [U.S. Pat. No. 4,631,857] is that it is a heterogeneous system, so the plaster particles containing the pesticides coming off the cork causes the sinking of the pesticide. These kinds of light components do not or just very slowly decompose, theerfore they float as a garbage on the water surface for weeks or even for months, the wind blows them near to the shore where they can accumulate and can cause environmental and utilization problems.

As far as the environmental protection is concerned employment of ice is favourable since its thawing product is water [WO98/28984]. However, the spreading of sticking ice particles causes unresolveable problems and leads to an inhomogeneous picture of the spread. Moreover, the product impregnated by the pesticide can be stored only in a cooled state, so—after putting it into an air or water craft—it has to be used up in an extremely short run to avoid surface thawing and sticking together. This is the main obstacle of the large-bulk economical transportation and employment.

The use of oily-products forming a thin coating on the water surface and the employment of other products such as the mosquito-larvae killing products [U.S. Pat. No. 1,831,476, U.S. Pat. No. 5,273,967, U.S. Pat. No. 4,707,359, GB 546,934] are disadvantageous from an environmental protection point of view. The problem is similar to the HU P0100491 procedure where sand granules covered with pesticide containing vegetable oil were used as spreading material. The oily sand granules can form aggregates, therefore the spreading picture cannot be homogeneous.

There are numerous biological and chemical products which can be suspended in water and can be used as liquids for the extermination of mosquito larvaes. The main problem of using these products are that the scope of spreading by spraying is short. Taking average humidity and temperature into consideration on a general summer day (season of mosquito extermination), the scope of spreading by spraying is 5-8 meters, since the sprayed water or liquid evaporates before reaching the surface. Besides the conventional spraying equipment, equipment with reciprocating and jet engines have been developed [HU 170,398], but these cannot solve the problem of the evaporation. Taking these into account, solid products and liquid films on solid carriers can be applicable, consequently there is a need for appropriate components that can float on water surface, they are environment friendly materials and dissolve or sink after killing the mosquito-larvaes.

The most comfortable application of solid materials can be realized by the use of air craft ensuring a wide scope of spraying by means of centrifugal plates. Similar spraying equipment can be used on different water crafts as well. Spraying of products carried by solid materials or of solid particles from a chopper with a centrifugal plate requires mechanically strong particles. However, carriers with appropriate strength (e.g. sand) have larger density than the water. Therefore the desired effect on the water surface could not be reached. The requirements mentioned above is extended further the need of an appropriate geometrical form of the partricle to ensure a long-distance homogeneous spreading.

Nowadays no mosquito-killing product can be found on the market that would meet the requirements described. Suitable pesticide product floats on the water surface, environment friendly, sufficiently strong for spreading, from air- or water-crafts, provides maximum scope of spreading and a granulate form for ensuring long spreading distance together with homogeneous distribution of spreaded particles, and finally disappears from the water surface (by sinking or dissolving) after spreading and killing the mosquito-larvaes.

In the present invention a new carrier material for biological mosquito larvae killing pesticides, new mosquito-larvae killing products containing this carrier material; the procedure for manufacture of the carrier and the mosquito-killing products; the way of their spreading; and the method of mosquito larva extermination with spreading from the air- or water-crafts are described.

The basis of this current invention is the creation of an advantageous geometrical—preferably a ball-shaped—form of granules, by the granulation of silicate rocks and well-shapable clay. By means of the removal of the organic matter from the clay at high temperatures, pores are created in a known way. Following this, by raising the temperature to a degree where the clay transforms into a material of earthenware hardness we can get the final carrier product in the suitable geometrical form and in homogeneous size distribution. The density of the granules less than the density of water due to the presence of the pores. This way the material can float on the water surface meanwhile its pores are very slowly filled with water. By the exchange of the air in the the pores for water, the density of the granules increases. When its density becomes higher than that of the water, the granulates start to sink.

The subject of this current invention is a clay composition that is burnt and strength from a mechanical point of view and contains pores. This clay composition has a homogeneous distribution of the granulate sizes and has an advantageous, preferably a ball-shaped geometrical form. It is capable of floating on the water surface for a certain period of time for some minutes or days until its pores are filled with water and, due to the increased density it sinks under the water surface. This product can advantageously be used as a supporting material for biological mosquito-larvae killing pesticides.

This present invention refers to those mosquito-larvae killing compositions containing biological pesticides that is known by itself and which also contain these pesticides that are found in the granules of the carrier material or they are stuck to the surface of it. The manufacture of the mosquito-larvae killing material granules also belongs to the current invention by using a procedure to fix the biological pesticides into the pores of the porous support material or onto its surface. One of the preferred embodiments of the present invention, when the biological mosquito-larvae killing pesticide is mixed in a water-soluble glue material or in the composition of stick can be based on carboxymethyl cellulose, starch or their mixtures, the surface of the support material is covered by these mixtures which are then washed off by the water during use in a natural environment. The surface containing the glue material is covered by an inert dust material, for example, by starch or mineral substances such as limestone or the dust of dolomite. This way sticking can be avoided. A preferred embodiment is when the support surface coated with the glue material is also covered by the dust of the biological mosquito-larvae killing material powder.

This invention also includes the spreading of the mosquito-larvae killing material products fixed on the support material mentioned above by the application of centrifugal plate on water or air crafts.

According to the present invention, before burning the clay to develop the pores of the biological mosquito-larvae killing material carrier material, the particles of the precursor material is formed into a ball-form which form is the most advantageous regarding air resistance and homogenity of the picture of spreading. The aim of the present invention is that the biological mosquito-larvae killing material products should cover the water surface as much as possible and ensure a large scope of spreading. The favorable ball diameter is 0.5-10 mm and the most favorable size is 2-6 mm. In the case of the 3 and 5 mm granulate in a ball diameter the relationship between the coverage and the scope of spreading is shown in the Table 1.

As it can be seen, the biological mosquito-larvae killing material product contains carrier material having a certain pore size (developed by our method), thus ensuring that the biological mosquito-larvae killing material product remains on the water surface for a time interval of 0.01-12 hours, then it sinks within 0.01-24 hours.

The present invention indicates that the support material and the biological mosquito-larvae killing material product covering the support material is transportable and storable due to its physio-chemical and biological stability and its mechanical strentgh. The mosquito-larvae killing material composition floats on the water surface until it has its effect, so the mosquito larvas are effectively destroyed by the spreaded products appearing at the habitat of the larvas. Having been developed its effect, the composition sinks within a few hours due to the increased density caused by the amount of water filling the pores. This way the accumulation of the carrier material on the shores and at the foot of the reeds, as well as the environmental and economic damage are avoidable. The support material is made up of silicate rocks, which does not cause any environmental damage neither in waters nor in their surroundings.

A given composition about mosquito larva extermination is introduced without restricting the claim of the patent.

### EXAMPLE 1

Carrier material: montmorillonit found in nature and shaped into balls of 3-6 mm in diameter size (bentonite clay mineral containing 6% organic matter) are heated at 200-400 C.° to burn the organic matter and to get the pore system, then they are further heated at 800-1200 C.° until reaches of strength an earthenware. After the granulates cool down they are classified according to their size, then are soaked in the water suspension containing 1% aq. carboxymethyl-cellulose and the biological mosquito-larvae killing material product containing Bacillus Thuirengiensis as an pesticide. This way composition of 4% pesticide is created.

Spreading experiments: A support heated at 350 and 800 C.° having a density of 0.6 kg/liter and a diameter of 3 and 5 mm was used. These compositions are under a scope-of-spreading analysis by a MI-2 chopper. The results can be seen in Table 1 with the data referring to the coverage in each square meter, and this is 5 and 10 kilogrammes in the case of the spreaded material. The granulates sink within 12-24 hours. The picture of spreading form was homogeneous and the scope of spreading showed 40-50 meters at each test.

TABLE 1
The maximum scope of spreading and the average coverage per square
meter is 5 and 10 kgs/hectare in the case of the spreaded material

| Amount of spreaded | Average diameter | Average covering |
|---|---|---|
| materials Kg/hectare | of the balls mm | pieces/m² |
| 5 | 3 | 20-21 |
| 10 | 3 | 40-42 |
| 5 | 5 | 4-5 |
| 10 | 5 | 9-10 |

1. A carrier material for biological mosquito-larvae-killing pesticides, comprising granules with a given size and geometrical form, mechanical strength, which contain pores, and basically build from a natural silicate mineral, preferably from a porous and burnt clay material.

2. A carrier material of claim 1, where the geometrical form of granules can be regular or irregular, and the most favorable form is ball shaped.

3. Carrier material of claim 2, where the size of the supporting material granules is 0.1-20 mm, favorably 3-6 mm in its diameter

4. Procedure for the preparation of the carrier material for the mosquito-larvae killing material products of claim 1, where a precursor mixture is created from the organic material containing clays and minerals in a given size and geometrical forms, then organic matters are burnt out by heating to develop pores, then further heating is performed until the product becomes as hard as an earthenware, and the precursor material is a mixture of various natural silicate rocks or bentonite and the most favorable ones are the montmorillonite or other known clay minerals and rocks containing organic matters.

5. A carrier material for biological mosquito-larvae-killing pesticides, comprising granules with a given size and geometrical form, mechanical strength, which contain pores, and basically build from a natural silicate mineral, preferably from a porous and burnt clay material, prepared by method of claim 4, where the pesticide material is bound on the surface or into the pores of the supporting material.

6. Composition of claim 5, where after spreading the composition containing the pesticide, the granules floats on the water surface until it has its effects, then within a few hours, preferably between 1-16 hours its pores are filled with water then sinks.

7. The method for preparation of biological pesticide-containing granules of claim 6, where the pesticides are bound to the surface or pores of granules of a carrier material for biological mosquito-larvae-killing pesticides, comprising granules with a given size and geometrical form, mechanical strength which contain pores and basically build from a natural silicate mineral, preferably from a porous and burnt clay material prepared by a procedure for the preparation of the carrier material for the mosquito-larvae killing material products, where a precursor mixture is created from the organic material containing clays and minerals in a given size and geometrical forms, then organic matters are burnt out by heating to develop pores, then further heating is performed until the product becomes as hard as an earthenware, and the precursor material is a mixture of various natural silicate rocks or bentonite and the most favorable ones are the montmorillonite or other known clay minerals and rocks containing organic matters, with known methods.

8. The method of claim 7, where the biological pesticide is bound to granules or into their pores with a mixture of the biological pesticide with water-soluble glue materials, preferably with carboxymethylcellulose, starch, or with their mixtures.

9. The method of claim 8, where after performing the procedure of claim 8, the surface will be covered by inert dust, favorably by starch powder or mineral materials like the dust of silicate rocks, or the most preferablely by calcium-carbonate, dolomite or dust of other solid envionmental friendly materials.

10. The preparation method of claim 7, where the granulates are soaked in the water solution of glue materials such as carboximetil-cellulose or starch, or their mixtures, then the biological mosquito-larva killing pesticide or its mixture containing inert materials like stach powder, calcium-carbonate or dolomite are used in the glue material being on the surface.

11. The procedure of spraying of the biological mosquito-larvae killing pesticide containing granules of claim 6 prepared by the method for preparation of biological pesticide-containing the granules where the pesticides are bound to the surface or pores of the granules of a carrier material for biological mosquito-larvae-killing pesticides, comprising granules with a given size and geometrical form, mechanical strength, which contain pores, and basically build from a natural silicate mineral, preferably from a porous and burnt clay material prepared by a procedure for the preparation of the carrier material for the mosquito-larvae killing material products, where a precursor mixture is created from the organic material containing clays and minerals in a given size and geometrical forms, then organic matters are burnt out by heating to develop pores, then further heating is performed until the product becomes as hard as an earthenware, and the precursor material is a mixture of various natural silicate rocks or bentonite and the most favorable ones are the montmorillonite or other known clay minerals and rocks containing organic matters, with known methods, when the spreading happens in a known way, meaning by water or air-craft, preferably with the help of a centrifugal plate.

12. The method of mosquito larva extermination performed by water or air-craft, where the extermination is proceeding by using granules prepared by a method for preparation of biological pesticide-containing the granules where the pesticides are bound to the surface or pores of the granules of a carrier material for biological mosquito-larvae-killing pesticides, comprising granules with a given size and geometrical form, mechanical strength, which contain pores, and basically build from a natural silicate mineral, preferably from a porous and burnt clay material prepared by a procedure for the preparation of the carrier material for the mosquito-larvae killing material products, where a precursor mixture is created from the organic material containing clays and minerals in a given size and geometrical forms, then organic matters are burnt out by heating to develop pores, then further heating is performed until the product becomes as hard as an earthenware, and the precursor material is a mixture of various natural silicate rocks or bentonite and the most favorable ones are the montmorillonite or other known clay minerals and rocks containing organic matters, with known methods and the spraying of claim 11.
